(19) United States
(12) Patent Application Publication
(10) Pub. No.: US 2009/0262136 A1
(43) Pub. Date: Oct. 22, 2009

(54) Methods, Systems, and Products for Transforming and Rendering Media Data

(76) Inventors: Steven N. Tischer, Atlanta, GA (US); Karl Cartwright, Dacula, GA (US); Jerry Liu, Atlanta, GA (US)

Correspondence Address: AT&T Legal Department - SZ;Attn: Patent Docketing, Room 2A-207, One AT&T Way, Bedminster, NJ, 07921, US

(21) Appl. No.: 12/107,232

(22) Filed: Apr. 22, 2008

(51) Int. Cl. G09G 5/00

(52) U.S. Cl. 345/629

(57) ABSTRACT

Methods, systems, and products are disclosed for transforming and rendering scenes of video data. A frame of video data is stored as a scene file. Components within the scene are edge detected, such that boundaries of the components of the scene are determined. The edge-detected components are saved as a first synthesized scene file describing the scene. The minor components of the scene are discarded, and the remaining major components are saved as a second synthesized scene file describing the scene. Vectors describing the boundaries of the major components are saved as a third synthesized scene file describing the scene. When a request is received for the frame of video data, any of the scene files may be returned to a requesting device, depending on bandwidth and/or cost.

### NOTICE OF COPYRIGHT PROTECTION

A portion of this disclosure and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to computer graphics processing and selective visual display systems and, more particularly, to adjusting the level of detail, to graphic manipulation, to merging and overlay, to placing generated data into a scene, and to morphing.

Full fidelity video data may be unsuitable in some circumstances. When high quality, full-resolution (or “full fidelity”) video data is sent to a destination, the video data may require a high quality communication channel that is suitable for unfaltering, continuous streaming of content. Sometimes, though, bandwidth bottlenecks occur, such that a communications network is unable to transfer enough data to accurately reproduce full-fidelity video, resulting in a choppy visual experience. Moreover, sometimes the receiving communications device (such as a cell phone or personal digital assistant) lacks the processing power, memory, and/or display characteristics to accurately reproduce full-fidelity video. There are, in fact, many examples of network and/or device constraints that may make full-fidelity video too expensive and/or too slow to reproduce.

### SUMMARY

The exemplary embodiments describe methods, systems, and products for transforming media data. The term “media data” may be video data, but media data may also encompass purely audio data, static or still pictures, music, games, television, or any other digital or analog data. Exemplary embodiments transform media data into lower-resolution alternatives that may be cheaper, and/or faster, to communicate and to process. A frame of the media data is stored, and components of a scene within the frame are edge-detected to determine the components' boundaries. The edge-detected components are stored as a first synthesized file. Minor components within the scene may be discarded, such that major components remain. The major components are saved as a second synthesized file. The vectors describing the boundaries of the major components may be determined and saved as a third synthesized file describing the frame of media data. Each of these lower-resolution alternatives may be a cheaper and/or a faster transformation of the media data.

0Another exemplary embodiment describes a method of rendering media data. A vector representation of the media data is received, and the vector representation includes mathematical vectors that describe a boundary of an edge-detected component within a frame of the media data. A set of attributes may also be received. The mathematical vectors may be rendered using the set of attributes to present a synthesized image of the media data.

In another of the embodiments, a system is disclosed for transforming media data. Means are included for storing a frame of media data and for comparing a chrominance of a region in the frame to the chrominance of an adjacent region in the frame. Means are included for edge detecting boundaries of components within the frame using the chrominance. The edge-detected components are stored as a first synthesized file. Minor components within the scene may be discarded, such that major components remain. The major components are saved as a second synthesized file. The mathematical vectors describing the boundaries of the major components may be determined and saved as a third synthesized file. Means are included for receiving a request for the media data. Means are also included for sending a lower resolution alternative to the media data, the lower resolution alternative comprising at least one of i) the first synthesized file describing the edge-detected components, ii) the second synthesized file describing the major components within the frame, and iii) the third synthesized file of the mathematical vectors describing the boundaries of the major components within the frame.

In yet another embodiment, a computer program product is also disclosed. The computer program product stores processor-executable instructions or code for performing a method of transforming media data. A frame of the media data is stored, and components of a scene within the frame are edge-detected to determine the components' boundaries. The edge-detected components are stored as a first synthesized file. Minor components within the scene may be discarded, such that major components remain. The major components are saved as a second synthesized file. The vectors describing the boundaries of the major components may be determined and saved as a third synthesized file describing the frame of media data. Each of these lower-resolution alternatives may be a cheaper and/or a faster transformation of the media data.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating a network environment in which exemplary embodiments may be implemented;

FIG. 2 is a schematic further illustrating a server-side transformation application, according to more exemplary embodiments;

FIG. 3 is a schematic that visually illustrates some lower-resolution transformations, according to more exemplary embodiments;

FIGS. 4-6, 7A-7D, 8A-8D, and 9A-9B are schematics illustrating the edge-detection of components within a frame of media data, according to more exemplary embodiments;

FIGS. 10A and 10B are schematics illustrating additional simplifications for each edge-detected transformation, according to still more exemplary embodiments;

FIG. 11 is a schematic illustrating color simplifications, according to still more exemplary embodiments;

FIGS. 12A and 12B are schematics illustrating a vectorization of boundaries, according to still more exemplary embodiments;

FIGS. 13A-13C are further schematics that visually summaries the various transformations, according to more exemplary embodiments;

FIGS. 14-16 are more detailed schematics illustrating a process of providing requested media, according to more exemplary embodiments;

FIGS. 17 and 18 are flowcharts illustrating edge-detection using luminance, according to even more exemplary embodiments;

FIG. 19 is a schematic illustrating instantiation at the user's electronic device 108, according to even more exemplary embodiments;

FIG. 20 is a schematic illustrating multiple instantiations at the user's electronic device 108, according to even more exemplary embodiments;

FIG. 21 is a schematic illustrating another operating environment, according to even more exemplary embodiments;

FIG. 22 is a schematic illustrating color selections, according to even more exemplary embodiments;

FIG. 23 is a schematic illustrating downloadable attributes, according to even more exemplary embodiments;

FIG. 24 is a schematic illustrating the transmission of attributes 502, according to even more exemplary embodiments;

FIG. 25 depicts other possible operating environments, according to more exemplary embodiments;

FIG. 26 is a flowchart illustrating a method of transforming media data, according to still more exemplary embodiments; and

FIG. 27 is a flowchart illustrating a method of rendering media data, according to still more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

Exemplary embodiments describe methods, systems, and products for transforming and rendering media data. As many readers realize, the transmission of high-resolution, full fidelity media often requires a high bandwidth communication channel, along with suitable performance characteristics at the receiving device. Often times, though, there are network and/or device constraints that may make full-fidelity media too expensive and/or too slow to reproduce. Exemplary embodiments, then, describe lower-quality alternatives to full-fidelity data. These lower quality alternatives may require less bandwidth to transmit, and these lower quality alternatives may require reduced performance characteristics at the receiving device. Exemplary embodiments may thus transform full-fidelity media data into different data sets of different qualities. As later paragraphs will explain, exemplary embodiments may transform the full-fidelity media data into one, or even several lesser quality and more simplistic manifestations. Exemplary embodiments may even perform further transformations, such that the full-fidelity media data is reduced to a minimalistic vector data set that can be simply processed by the receiving device. These transformations, though, may be completely user-selectable, in that a user of the receiving device may select how much transformation is desired. If, for example, the end user must have full-fidelity video data, and the end user is willing to wait and to pay for that full-fidelity video data, then exemplary embodiments are able to provide the full-fidelity video data. When, however, a surreal, synthetic, or otherwise simplistic manifestation of video scenes will suffice, the end user may save time and money by opting for various lower-resolution transformations of the video data. These transformations may require less transmission resources and less processing and graphics capabilities at the receiving device.

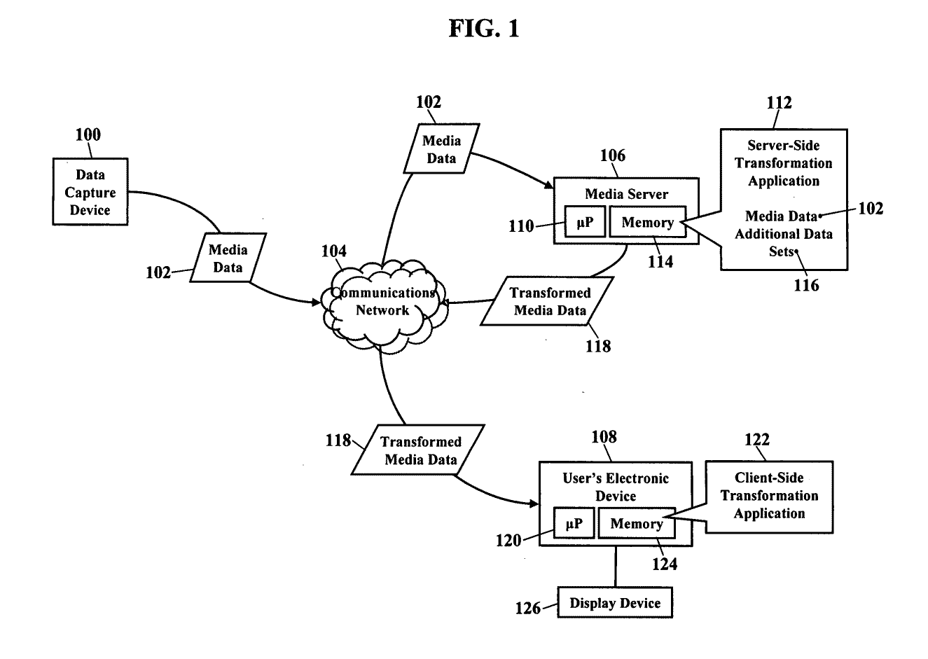

FIG. 1 is a simplified schematic illustrating a network environment in which exemplary embodiments may be implemented. A data capture device 100 captures and stores media data 102. The data capture device 100 may be any device that is capable of capturing, recording, and/or storing visual and/or audible data, such as a camera, microphone, or other audio-visual sensor. The media data 102 may be any data stored by the data capture device 100. The data capture device 100 transfers or sends the media data 102 via a communications network 104 to a media server 106. The media server 106 also communicates with a user's electronic device 108 via the communications network 104.

The media server 106 stores the media data 102 received from the data capture device 100. The media server 106 comprises a processor 110 (e.g., “μP”), application specific integrated circuit (ASIC), or other similar device that executes a server-side transformation application 112 stored in memory 114. The server-side transformation application 112 may comprise processor-executable instructions that transform the media data 102 into one or more additional data sets 116. According to exemplary embodiments, the media data 102 may be transformed into lower-quality and/or lower resolution versions that are cheaper and/or faster to send to the user's electronic device 108. The media data 102 may also be transformed into lower resolution versions that are easier to render at the user's electronic device 108. However the media data 102 is transformed, the server-side transformation application 112 causes the processor 110 to send transformed media data 118 to the user's electronic device 108.

The user's electronic device 108 receives the transformed media data 118. According to exemplary embodiments, the user's electronic device 108 comprises a processor 120 (e.g., “μP”), application specific integrated circuit (ASIC), or other similar device that executes a client-side transformation application 122 stored in memory 124. The client-side transformation application 122 may comprise processor-executable instructions that render or instantiate the transformed media data 118 at the user's electronic device 108. The client-side transformation application 122, for example, may cause the processor 120 to visually present the transformed media data 118 on a display device 126. If the transformed media data 118 has audio portions, the audio portions may also be audibly produced.

The media server 106 and the user's electronic device 108 are only simply illustrated. Because the architecture and operating principles of computers, communications devices, and other processor-controlled devices are well known, details of the hardware and software components of these devices are not further shown and described. If, however, the reader desires more details, the reader is invited to consult the following sources: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} edition 2005); and DAVID A. PATTERSON & JOHN L. HENNESSY, COMPUTER ORGANIZATION AND DESIGN: THE HARDWARE/SOFTWARE INTERFACE (3^{rd} Edition 2004).

Exemplary embodiments may be applied regardless of networking environment. The communications network 104 may be a cable network operating in the radio-frequency domain and/or the Internet Protocol (IP) domain. The communications network 104, however, may also include a distributed computing network, such as the Internet (sometimes alternatively known as the “World Wide Web”), an intranet, a local-area network (LAN), and/or a wide-area network (WAN). The communications network 104 may include coaxial cables, copper wires, fiber optic lines, and/or hybrid-coaxial lines. The communications network 104 may even include wireless portions utilizing any portion of the electromagnetic spectrum and any signaling standard (such as the I.E.E.E. 802 family of standards, GSM/CDMA/TDMA or any cellular standard, and/or the ISM band, and/or satellite networks). The concepts described herein may be applied to any wireless/wireline communications network, regardless of physical componentry, physical configuration, or communications standard(s). Exemplary embodiments are also applicable to any television system and/or delivery mechanism. Exemplary embodiments may be applied to analog television, digital television, standard and/or high definition television, cable television network systems, and Internet Protocol television network systems.

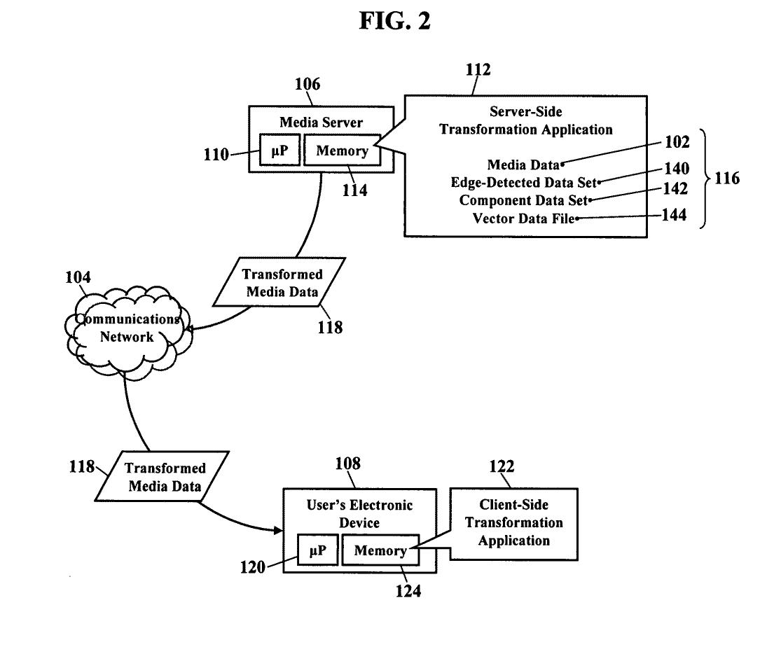

FIG. 2 is a schematic further illustrating the server-side transformation application 112, according to more exemplary embodiments. FIG. 2 illustrates the transformation of the media data 102 into the one or more additional data sets 116. The server-side transformation application 112, for example, may first transform the media data 102 into an edge-detected data set 140. As later paragraphs will explain, the edge-detected data set 140 may be of lower resolution than the full-fidelity media data 102. The server-side transformation application 112, however, may continue the transformation and discard portions of the edge-detected data set 140, thus creating a component data set 142. The component data set 142 may be of lower resolution than the edge-detected data set 140, where minor, unimportant portions of the media data 102 are discarded or “thrown out.” The server-side transformation application 112 may even continue the transformation and convert the component data set 142 into a vector data file 144, where the vector data file 144 may have an even lower resolution than the component data set 142. Later paragraphs will explain these transformations in greater detail, and exemplary embodiments may even include more transformations. Suffice it to say here, though, that these additional data sets 116 may be progressively lower-resolution versions of the full-fidelity media data 102, according to exemplary embodiments. Any of these lower-resolution versions may be sent to the user's electronic device 108 as a cheaper, faster, and/or simpler alternative to the full-fidelity media data 102.

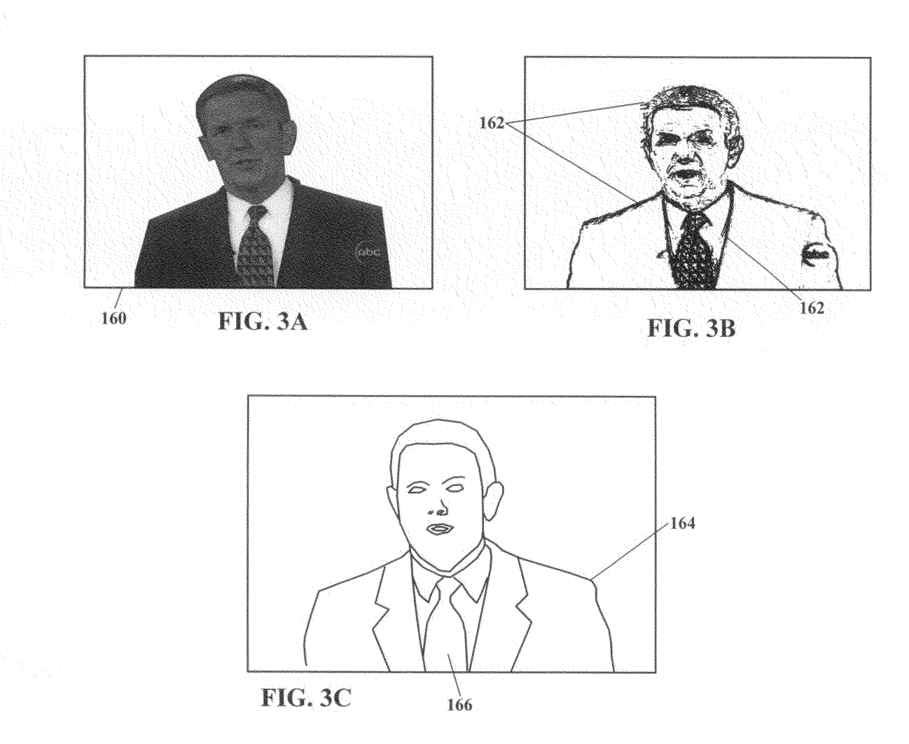

FIG. 3 is a schematic that visually illustrates some of these lower-resolution transformations, according to more exemplary embodiments. FIG. 3A is a single, full-fidelity frame 160 of the media data (illustrated as reference numeral 102 in FIGS. 1-2). The full-fidelity frame 160 illustrates a scene in which a news anchorman speaks against a background. FIG. 3B illustrates an edge-detected transformation of the full-fidelity frame 160 of the media data 102, according to exemplary embodiments. As later paragraphs will explain, exemplary embodiments may utilize edge detection techniques to detect the components of the scene depicted within the frame 160 of the media data 102. The edge detection techniques determine the boundaries 162 of the components of the scene. FIG. 3C illustrates a vectorized transformation of FIG. 3B, again according to more exemplary embodiments. Once the boundaries 162 of the components are known, exemplary embodiments may also determine the mathematical vectors that describe the boundaries 162. FIG. 3C illustrates a plotting, tracing, or graphing 164 of those vectors, resulting in a synthesized, black-and-white, minimalistic representation of the scene (e.g., the news anchorman). Even though the news anchorman has been transformed into an animated, almost cartoon-like character, exemplary embodiments still retain the real-time contextual information of the full-fidelity frame 160, albeit in a cheaper, faster, and simpler presentation. As later paragraphs will also explain, exemplary embodiments may even discard or delete minor and/or unimportant components within the frame 160 that lend little or no informational meaning (notice, for example, that the details within the anchorman's tie 166 have been deleted from FIG. 3C). If the edge-detected (FIG. 3B) or the vectorized (FIG. 3C) transformations are sufficient for the user's needs, the user may save money and time by opting for lower-resolution transformations of the media data 102. Some users, in fact, may even prefer the vectorized (FIG. 3C) transformation as a fun, animated version of the full-fidelity frame 160.

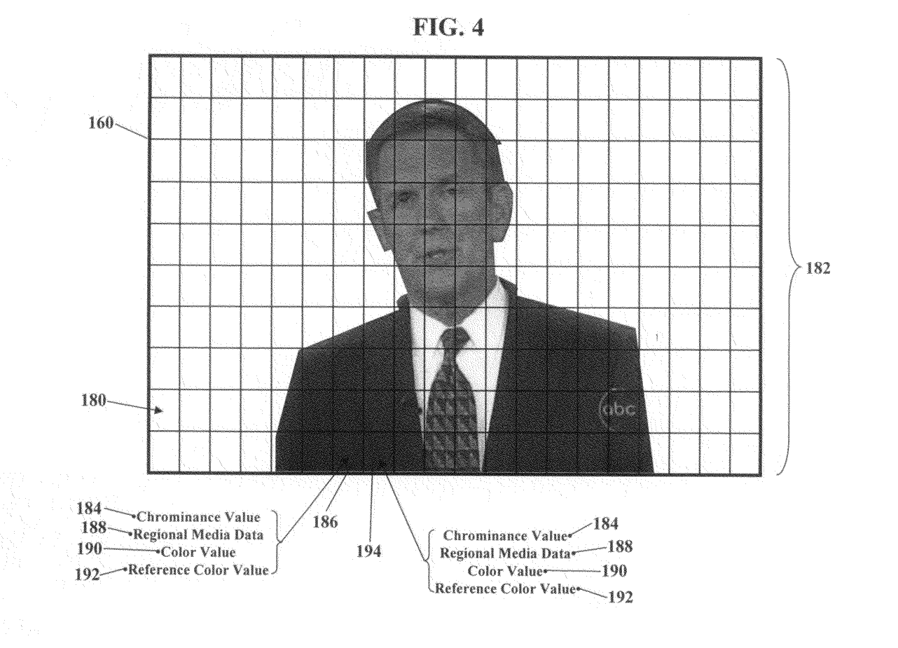

FIGS. 4-6 are schematics illustrating the edge-detection of components within the frame 160, according to more exemplary embodiments. Now that the reader has a basic understanding, this disclosure will now begin a fuller explanation of these transformations. FIGS. 4-6 illustrate how edge-detection is used to transform the full-fidelity media data (illustrated as reference numeral 102 in FIGS. 1-2) into component boundaries. Exemplary embodiments may retrieve the single, full-fidelity frame 160 of the media data 102 and then use edge detection techniques to detect the components within the frame 160. Edge detection results in determining or defining the boundaries 162 of the components within the frame 160 (as FIGS. 3A and 3B illustrated). There are many known techniques for edge-detecting features or components within a scene or frame, and any of these known techniques are adaptable to exemplary embodiments. Here, though, exemplary embodiments may utilize chrominance to differentiate components within the frame 160. The term and concept of chrominance, as used herein, describes a difference between a color value and a reference color value, with the reference color value having a specified color quality or numeric value. The difference between the color value and the reference color value is termed “chrominance.”

Exemplary embodiments, then, may compare regional chrominances. As FIG. 4 illustrates, exemplary embodiments may divide the frame 160 of the media data 102 into regions 180. Although the regions 180 may have any shape and configuration, for simplicity, FIG. 4 illustrates the regions 180 having a rectangular shape (each region 180, then, may be considered a “cell”). The number of regions 180 is configurable according to the desired resolution. If greater resolution is desired, then the number of regions (or “cells”) 180 may be increased. If, however, lower resolution is desired, then the number of regions 180 may be decreased. Even though the number of regions 180 may be determined using any manner, preferably the number of regions 180 are determined based on the display characteristics of the user's electronic device (illustrated as reference numeral 108 in FIGS. 1-2). When, for example, the display device 126 of the user's electronic device 108 is small (such as a phone or PDA), then the number of regions or cells may be small compared to a wide-screen computer monitor or television (which may have many hundreds or thousands of regions or cells). FIG. 4, for illustrative purposes, illustrates the regions 180 with horizontal and vertical gridlines 182. As a default value, exemplary embodiments may divide the frame 160 into n equal-area regions, such that each region has an area A equal to:

$$A = \frac{ScreenSize}{n} ,$$

where Screen Size is preferably the size of the display 126 associated with the user's electronic device 108. Screen Size may be measured in inches, millimeters, pixels, or any other unit of measurement. As the number n of regions 180 increases, each region's area is reduced, thus increasing the resolution of details and components within each region. FIG. 4, for clarity, only illustrates about 200 of the regions 180 (i.e., a grid of 10 rows and 20 columns). In practice, though, the regions 180 may be smaller in area, and the number of cells may number in the many hundreds or thousands to improve the accuracy of the transformations.

A chrominance value 184 is calculated for each region 180. As FIG. 4 illustrates, a first region 186 is selected and the server-side transformation application 112 collects regional media data 188 that corresponds to the first region 186. The regional media data 188 is the subset of the media data 102 that corresponds to the first region 186. The server-side transformation application (illustrated as reference numeral 112 in FIGS. 1-2) then assigns a color value 190 to the first region 186. The assigned color value 190 may be an average color value of all the numeric color values within the first region 186. The assigned color value 190 may additionally or alternatively be a dominant color value that most frequently occurs within the first region 186. Exemplary embodiments, for example, may tally the different color values that occur within the first region 186. The color value having the greatest number of occurrences may be dominant. The assigned color value 190 may additionally or alternatively be a median color value in the spectrum of numeric color values that occurs within the first region 186. Exemplary embodiments may tally the different color values that occur within the first region 186, determine a Gaussian distribution for the different color values, and then compute the median color value.

Regardless, the server-side transformation application 112 assigns the color value 190 to the first region 186. The server-side transformation application 112 may then compare the assigned color value 190 to a reference color value 192. The chrominance value 184 is the difference between the assigned color value 190 and the reference color value 190. The server-side transformation application 112 then selects a second region 194, collects the regional media data 188 that corresponds to the second region 194, assigns a corresponding color value (such as the color value 190) to the second region 194, and computes the corresponding chrominance value 184 for the second region 194. The server-side transformation application 112 may repeat these calculations for each of the remaining regions or cells 180.

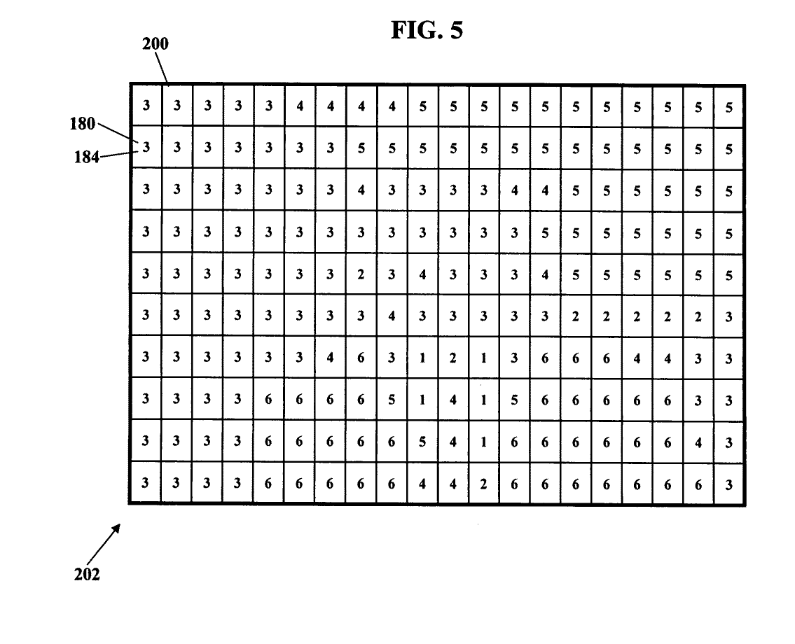

FIG. 5 illustrates a data table 200 of chrominance values 184 for the frame 160 of the media data 102, according to more exemplary embodiments. Once the chrominance value 184 is calculated for each region 180, the server-side transformation application 112 may construct a matrix 202 of the chrominance values 184. The matrix 202 preferably has the same row and column configuration as the regionalized frame 160 of the media data 102 (although the matrix 202 may have a different row/column configuration). That is, when the frame (illustrated as reference numeral 160 in FIG. 4) is divided into rows and columns of the equal-area regions or cells 180, the matrix 202 of chrominance values 184 has the same number of rows and columns. FIG. 5 illustrates each region 180 having its corresponding chrominance value 184. The server-side transformation application (illustrated as reference numeral 112 in FIGS. 1-2) may store and maintain the matrix 202 of chrominance values 184 in the memory (illustrated as reference numeral 114 in FIGS. 1-2). The server-side transformation application 112 may also compute a corresponding matrix (such as the matrix 202) of chrominance values 184 for each corresponding frame of the media data 102. The server-side transformation application 112 may then save each frame's corresponding matrix 202 of chrominance values 184.

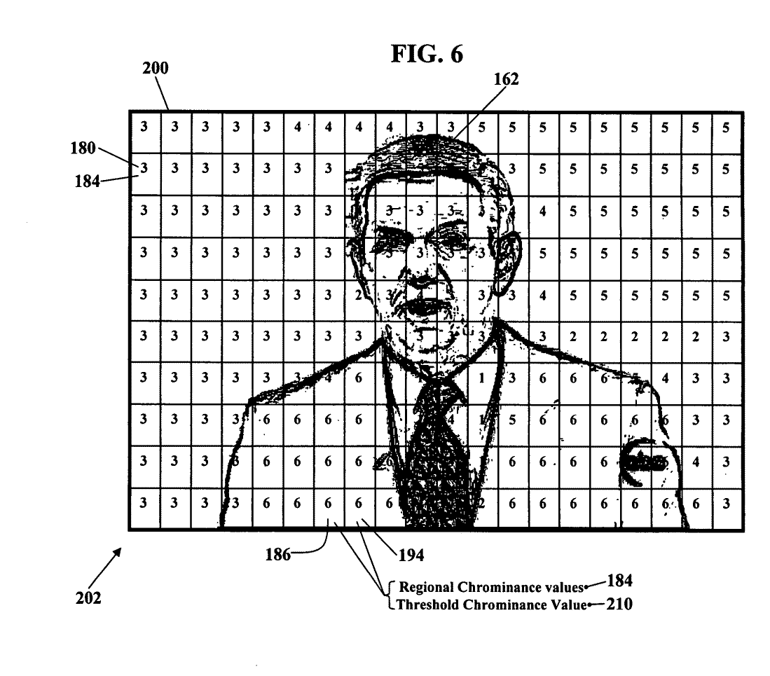

FIG. 6 is a schematic illustrating boundary determinations using chrominance, according to even more exemplary embodiments. Here exemplary embodiments determine the boundaries of components within the frame 160 using each region's chrominance value 184. Once the server-side transformation application (illustrated as reference numeral 112 in FIGS. 1-2) calculates the chrominance value 184 for each region 180, the server-side transformation application 112 may then compare the chrominance values 184 of adjacent regions 180. As FIG. 6 illustrates, the server-side transformation application 112 selects a region (perhaps the first region 186) and the second, adjacent region 194. The server-side transformation application 112 may then query the matrix 202 and retrieve each region's corresponding chrominance value 184. According to exemplary embodiments, the server-side transformation application 112 may calculate a difference between the chrominance values 184 of the adjacent regions 186 and 194. When the difference between the chrominance values 184 of the adjacent regions 186, 194 exceeds a threshold chrominance value 210, then exemplary embodiments may determine that a boundary (such as boundary 162) exists between the adjacent regions 186 and 194. In other words, if the adjacent chrominance values 184 differ by at least the threshold chrominance value 210, then exemplary embodiments may assume a boundary (such as boundary 162) exists. FIG. 6, for clarity, only illustrates a relatively small number of about 200 of the regions (smaller cells would be difficult to graphically illustrate and difficult to perceive with the human eye). Mathematically, though, the number of regions may be smaller in area and number in the many hundreds or thousands to improve the accuracy of the boundary determinations.

The threshold chrominance value 210 helps approximate the boundaries 162 between components. As those of ordinary skill in the art understand, there can be many components of a scene within the frame 160. When the chrominance values 184 differ between adjacent regions (such as regions 186 and 194), the difference may indicate the boundary 162 between components. The threshold chrominance value 210 is then used to help ensure the difference in chrominance values 184 truly signifies the boundary 162. A small difference in chrominance values 184, for example, may only indicate a difference in shading within a single component. The threshold chrominance value 210 is used to differentiate minor changes in chrominance from greater changes that indicate the boundary 162 between components. The threshold chrominance value 210, then, may be a minimum boundary condition that must be satisfied. So, when the threshold chrominance value 210 is satisfied, exemplary embodiments infer that the boundary 162 is present. Again, when the number of regions 180 is relatively large (e.g., many hundreds or thousands), the area of each region 180 is small, so the boundary 162 may be approximated as running or lying along the border of adjacent regions 180. Exemplary embodiments may thus compare all the adjacent chrominance values 184 to the threshold chrominance value 210. Whenever the threshold chrominance value 210 is satisfied, the boundary 162 may exist between adjacent regions 180.

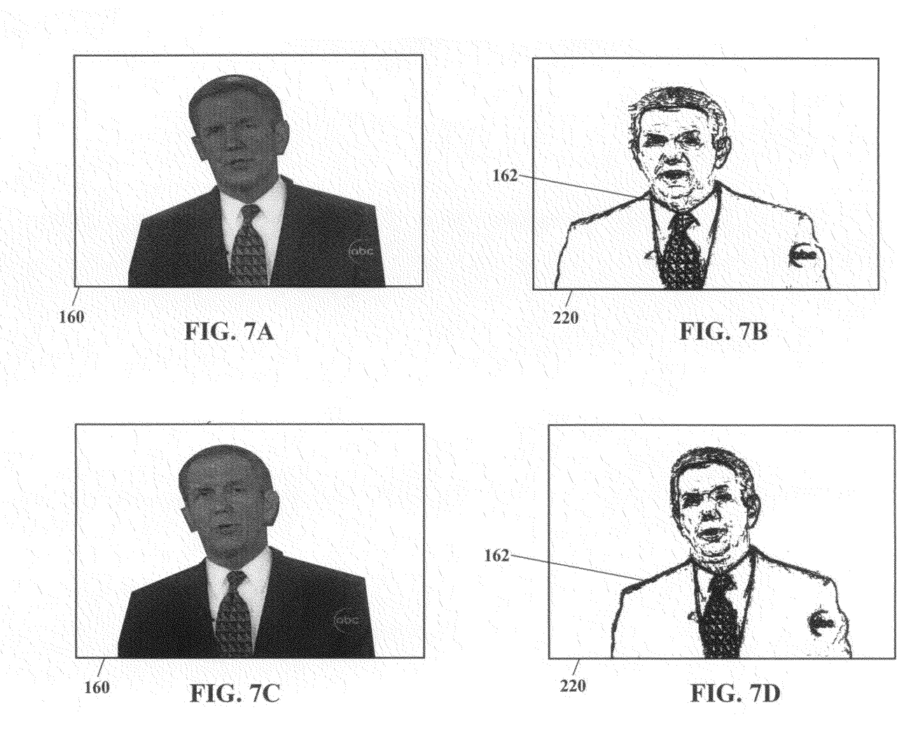

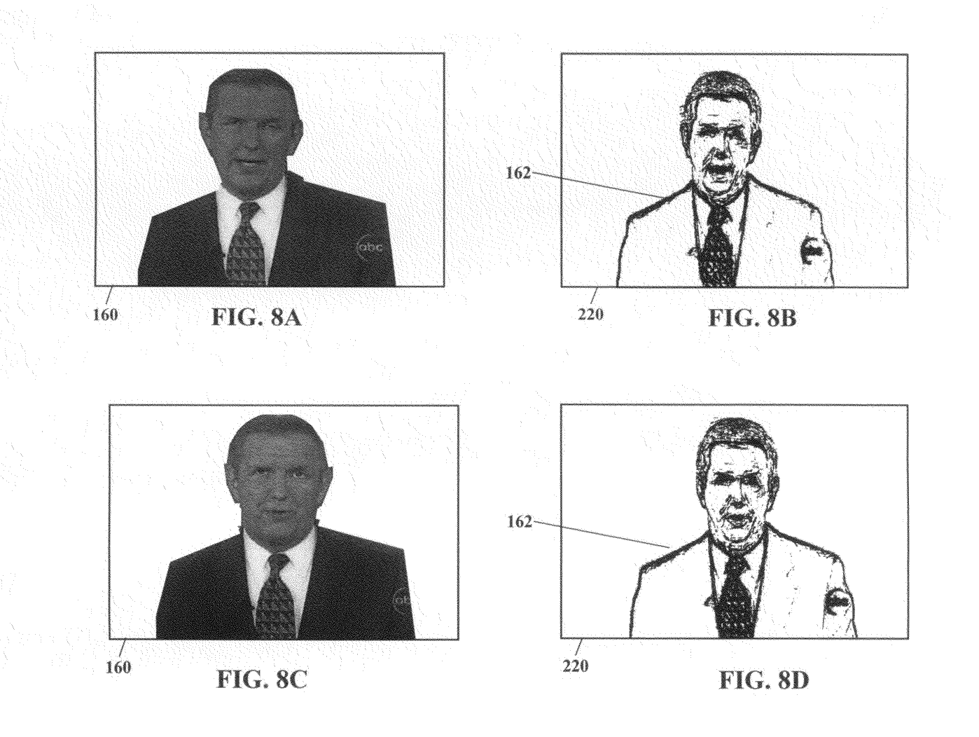

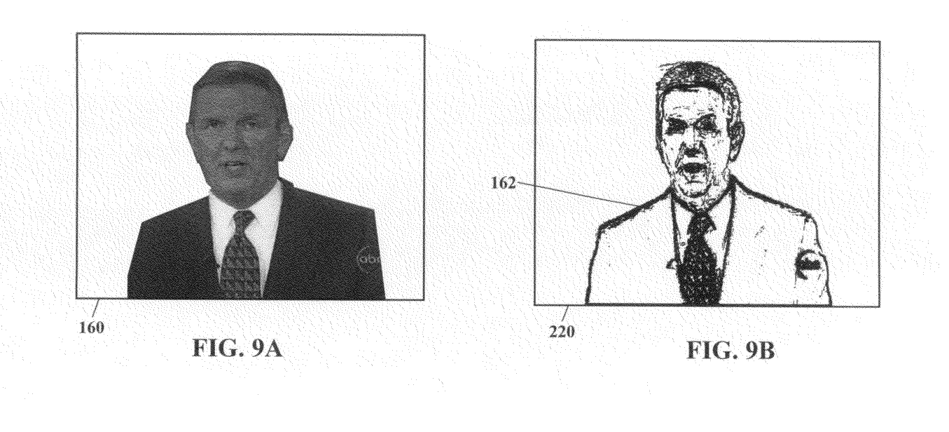

FIGS. 7A-7D, 8A-8D, and 9A-9B, then, are schematics illustrating various edge-detected versions of the individual frames 160 of the media data 102. When the server-side transformation application 112 receives the media data 102 (as illustrated in FIG. 1), the server-side transformation application 112 may transform the individual frames 160 of the media data 102 into lower-resolution, edge-detected versions. FIGS. 7A-7D, 8A-8D, and 9A-9B, for example, illustrate sequential frames 160 of the media data 102 and each frame's corresponding edge-detected transformation 220. FIGS. 7A, 7C, 8A, 8C, and 9A are illustrations of the full-fidelity frames 160, while FIGS. 7B, 7D, 8B, 8D, and 9B are the corresponding edge-detected transformations 220. The server-side transformation application 112 may save these edge-detected transformations as lower resolution versions of each corresponding frame 160. That is, the edge-detected components of each scene or frame 160 may be are saved as a synthesized, lower resolution transformation of each frame.

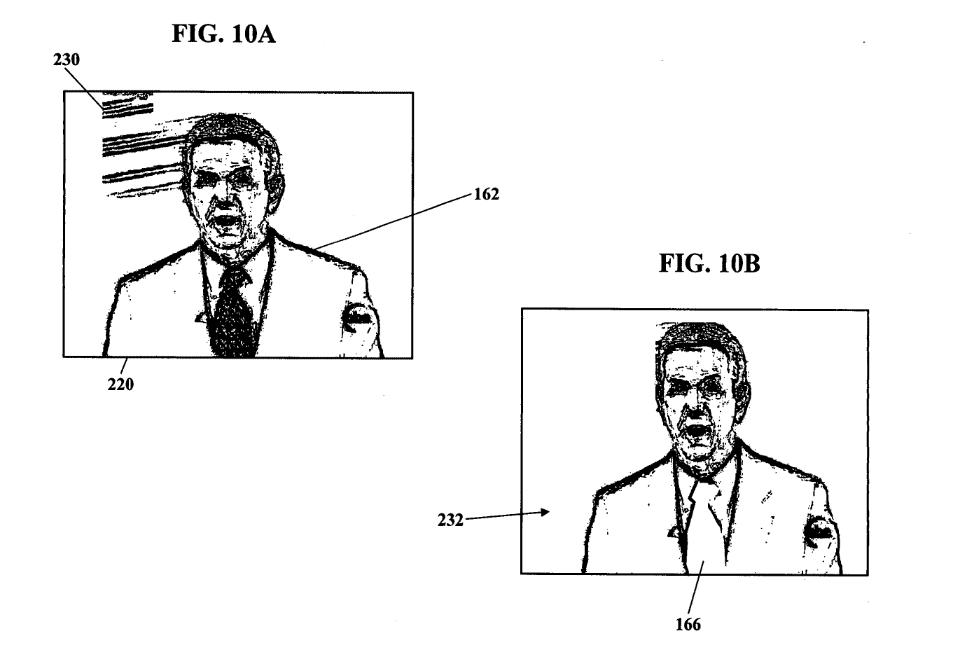

FIGS. 10A and 10B are schematics illustrating additional simplifications for each edge-detected transformations 220, according to still more exemplary embodiments. Here exemplary embodiments may discard, delete, or throw away some components that are minor and offer little or no informational context. The goal is to further reduce the bandwidth requirements and cost of transmitting each frame's edge-detected transformation 220. Exemplary embodiments may thus remove minor components, thus leaving only the major, informational components within the edge-detected transformation 220. For example, the geometrical details within the news anchor's neck tie 166 lend little or no informational context. As FIG. 10B graphically illustrates, exemplary embodiments may discard these unimportant, edge-detected components, thus merely leaving the boundary of the neck tie 166 (notice also that background streaks 230 have been removed). Exemplary embodiments may preferably remove any closed-perimeter components having a size or area smaller than each region (illustrated as reference numeral 180 in FIGS. 4-6). Recall that the number of regions 180 may be related to the size of the display associated with the user's electronic device 108. If an edge-detected component has an area smaller than the area of a region 180, then the component may be imperceptible to the user. Exemplary embodiments, then, may discard those components that are smaller than the regions 180. The server-side transformation application 112 may then save the major, edge-detected components 232 as further, lower resolution, synthesized version of each corresponding frame.

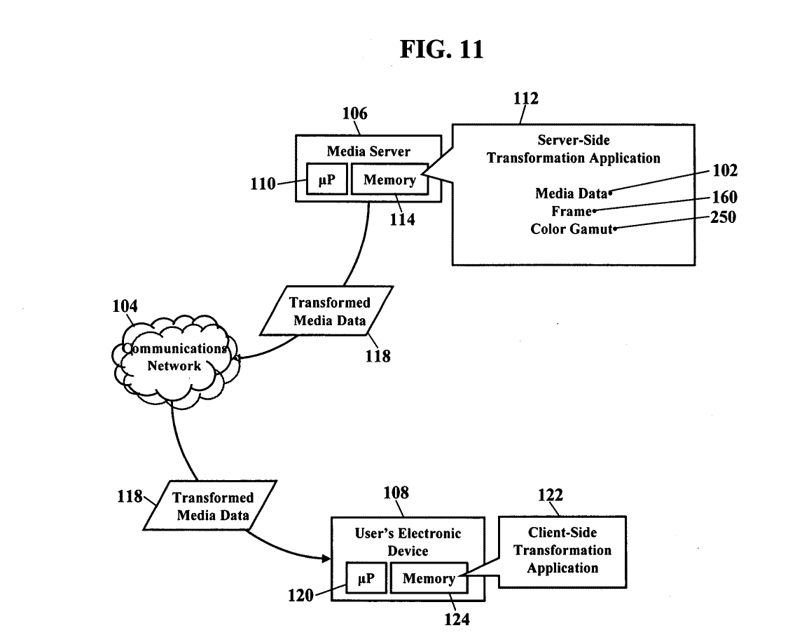

FIG. 11 is a schematic illustrating color simplifications, according to still more exemplary embodiments. Here, colors may also be discarded or replaced to further reduce bandwidth requirements and cost. The server-side transformation application 112 may access or retrieve a color gamut 250 from the memory 114. The color gamut 250 may specify permissible colors within the frame 160 of the media data 102. That is, if a color or hue within the frame 160 (and/or within an edge-detected component) is not specified in the color gamut 250, then the server-side transformation application 112 may discard that color or hue. The server-side transformation application 112 may even consult the color gamut 250 and replace the impermissible color/hue with another, permissible color from the color gamut 250. Exemplary embodiments, for example, may reduce a 256-color frame to eight colors, again to further reduce bandwidth requirements and transmissions costs. The server-side transformation application 112 may save these color-simplified, major, edge-detected components as additional, lower resolution, synthesized versions of each corresponding frame.

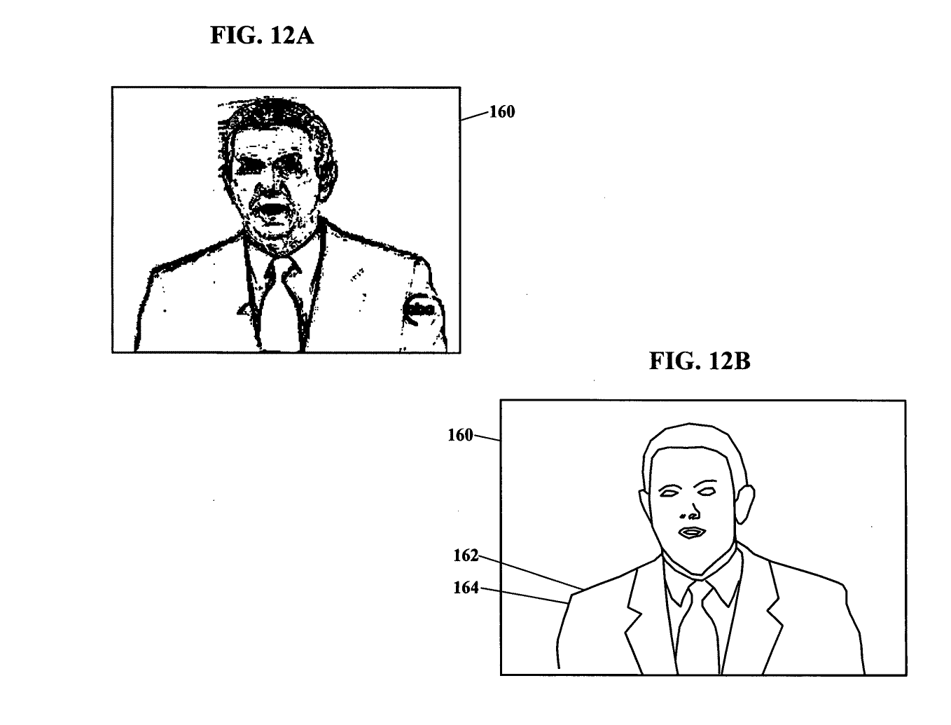

FIGS. 12A and 12B are schematics illustrating a vectorization of boundaries, according to still more exemplary embodiments. Now that the components within the frame 160 have been edge-detected (as FIGS. 4-6, 7A-7D, 8A-8D, and 9A-9B and their accompanying paragraphs explained), the minor components have been removed (as FIG. 10 illustrated), and color simplifications have been performed (as FIG. 11 illustrated), the boundaries 162 of the major components remain within the frame 160. Exemplary embodiments now determine or compute the mathematical vectors that describe the boundaries 162 of the major components. As earlier paragraphs explained, the chrominance values (illustrated as reference numeral 184 in FIGS. 4-6) between adjacent regions (illustrated as reference numeral 180 in FIGS. 4-6) may be used to determine the presence of a boundary condition. When the threshold chrominance value (illustrated as reference numeral 184 in FIG. 6) is satisfied, a boundary may be inferred. Exemplary embodiments may thus determine the mathematical vectors that describe these inferred boundaries 162 between components. Exemplary embodiments, in particular, may assume that the inferred, individual boundaries between the adjacent regions 180 are piecewise linear. That is, boundaries between the adjacent regions 180 may be linearly connected to form a continuous boundary. Inferred boundaries that are not between the adjacent regions 180 may be assumed to belong to a different boundary line. Once the boundaries are linearly constructed, exemplary embodiments determine the vectors that describe each boundary. Using this piecewise linear approximation, exemplary embodiments may thus construct another synthesized, lower-resolution version of each frame 160. FIG. 12A, then, illustrates the edge-detected, major components within the frame 160, while FIG. 12B illustrates the resultant graphical tracing 164 of the boundary vectors. FIG. 12B illustrates that the boundary vectors represent the lowest resolution transformation of the frame 160 that still maintains the informational content of the frame 160. Vectorization is well-known in computer graphics, so no further explanation of the boundary vectors is needed.

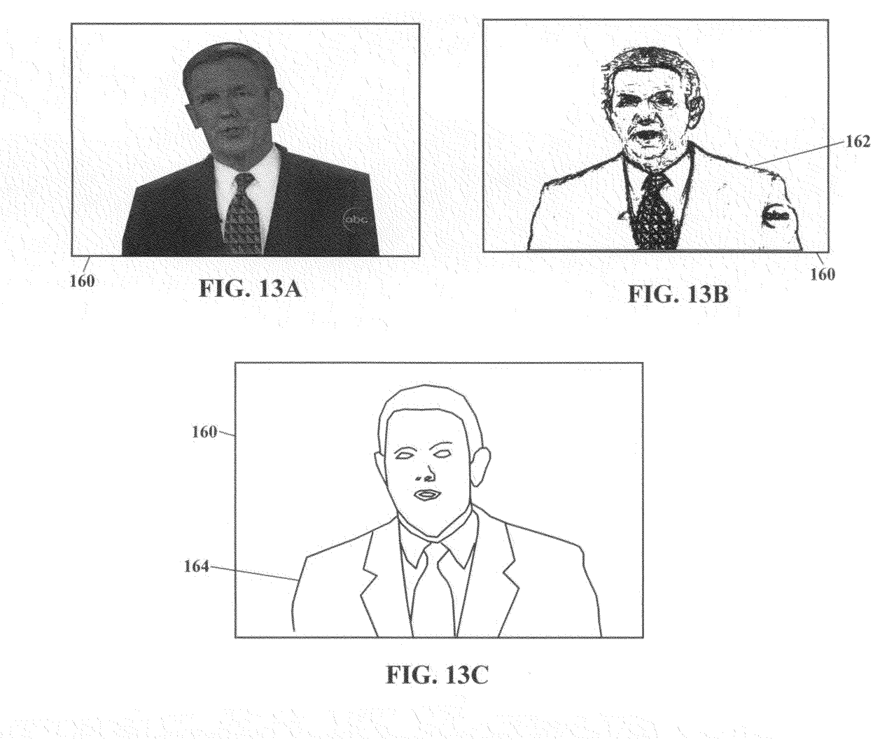

FIGS. 13A-13C are further schematics that visually summarize the various transformations, according to more exemplary embodiments. FIGS. 13A-13C illustrate the transformation of the full-fidelity frame 160 of the media data 102 into various lower-resolution simplifications and even synthesizations. FIG. 13A illustrates the full-resolution (full-fidelity) frame 160 of the media data 102, while FIG. 13B illustrates the frame's corresponding edge-detected boundary transformation 162. FIG. 13B also illustrates that the minor components have been purged, leaving only the major components that convey meaningful information. FIG. 13C illustrates a vectorized version of FIG. 13B, in which the mathematical vectors describe the tracing 164. Exemplary embodiments, then, have transformed the full-fidelity frame 160 into several lower resolution versions (e.g., the edge-detected boundary version of FIG. 13B and the vectorized version of FIG. 13C). Each transformation represents a lower resolution version of the full-fidelity frame 160. These transformations may be unsuitable at times, but at other times the transformations may be entirely adequate and even preferred. As later paragraphs will explain, the end user may thus completely decide when these lower-resolution transformations are preferred. If the edge-detected (FIG. 13B) or the vectorized (FIG. 13C) transformations are sufficient for the user's needs, the user may save money, and receive faster downloads, by opting for lower-resolution transformations of the media data 102.

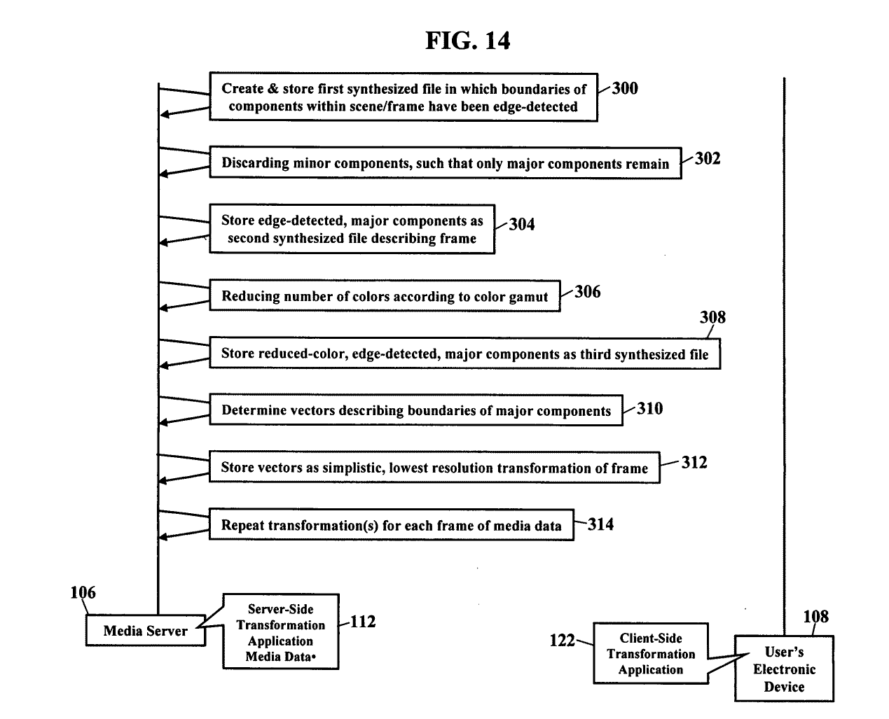

FIGS. 14-16 are more detailed schematics illustrating a process of providing requested media, according to more exemplary embodiments. As the above paragraphs explained, the server-side transformation application 112 may receive and convert the media data 102 into different, lower resolution transformations. The server-side transformation application 112, for example, may create and store a first synthesized file in which the boundaries of the components within the scene (or frame) have been edge-detected (Block 300). The server-side transformation application 112 may further reduce the resolution by discarding minor components within the frame, such that only the major components remain (Block 302). The server-side transformation application 112 may store the edge-detected, major components as a second synthesized file describing the frame (Block 304). The server-side transformation application 112 may further reduce the resolution by reducing the number of colors within the frame according to a color gamut (Block 306). The server-side transformation application 112 may store the reduced-color, edge-detected, major components as a third synthesized file describing the frame (Block 308). The server-side transformation application 112 may then determine the vectors describing the boundaries of the major components (Block 310). The server-side transformation application 112 may then store the vectors as the most simplistic and lowest resolution transformation of the frame (Block 312). Each transformation may be repeated for each frame of the media data 102 (Block 314).

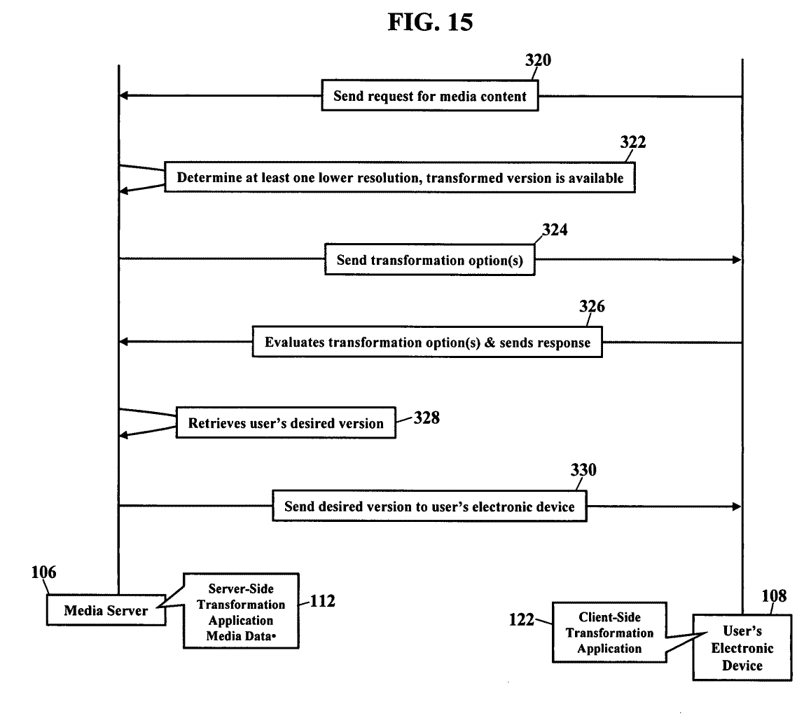

The process continues with FIG. 15. Now that the server-side transformation application 112 has transformed the full-fidelity media data 102 into various lower resolution versions, these lower resolution versions may be provided to users. As FIG. 15 illustrates, then, the user's electronic device 108 sends a request for media content (Block 320). When the media server 106 receives the request, the server-side transformation application 112 determines that at least one lower resolution, transformed version of the media data 102 is available (Block 322). The server-side transformation application 112 causes the media server 106 to send a transformation option to the user's electronic device 108 (Block 324). The transformation option indicates that at least one lower resolution, transformed version is available and may be suitable for the end user's needs. The transformation option, for example, may indicate that cheaper and faster alternative versions are available (e.g., the first synthesized file of the edge detected boundaries of the components, the second synthesized file describing only the edge-detected, major components, the third synthesized file describing the reduced-color, edge-detected, major components, and/or the fourth synthesized file describing only the vectors of the boundaries). When the transformation option is received at the user's electronic device 108, the user evaluates the transformation options and sends a response (Block 326). The response indicates whether or not a lower resolution, transformed version is acceptable. If a lower resolution option is acceptable, the response may also indicate which lower resolution, transformed version of the media data 102 is desired. The server-side transformation application 112 then retrieves the user's desired version (e.g., the full-fidelity media data 102 or one of the lower resolution, transformed versions) (Block 328) and sends the desired version to the user's electronic device 108 (Block 330).

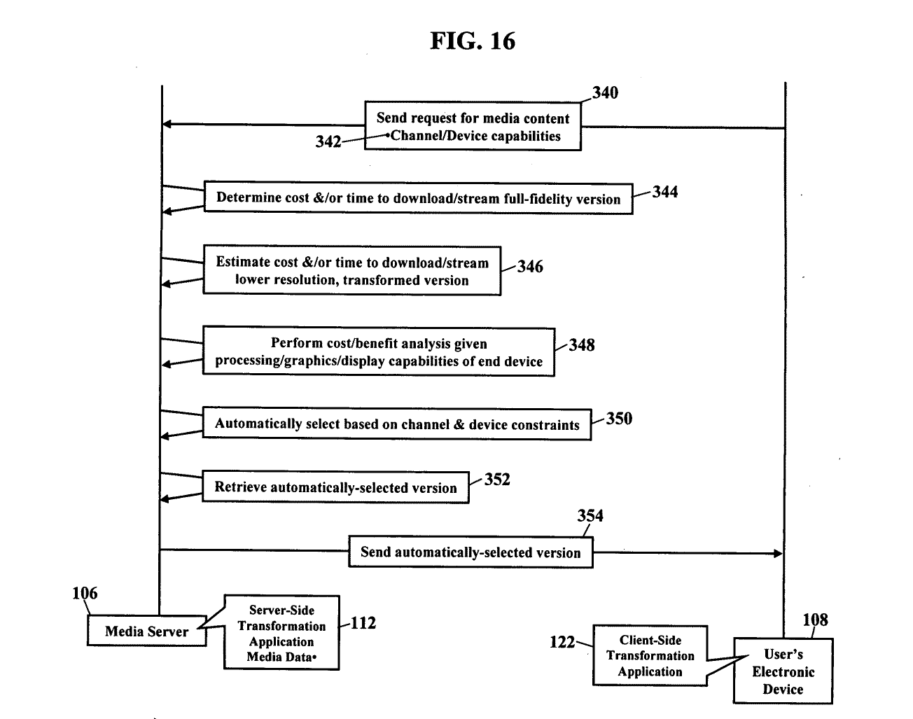

FIG. 16 is a schematic illustrating the automatic selection of lower resolution, transformed versions, according to more exemplary embodiments. Here, when the user's electronic device 108 sends the request for media content (Block 340), the request may include channel and/or device capabilities 342. The user's electronic device 108, for example, may send a maximum and/or minimum bitrate along a communication channel, a processor or graphics processing capability, and/or a display size or color capability of the user's electronic device 108. When the media server 106 receives the request, the server-side transformation application 112 may then use the channel and/or device capabilities to automatically determine which lower resolution, transformed version of the media data 102 may best suit the user's needs and the capabilities of the user's electronic device 108. The server-side transformation application 112, for example, may determine a cost and/or an amount of time that would be required to download or stream the full-fidelity version of the media data 102 to the user's electronic device 108, given the minimum “bottleneck” bitrate along the communication channel serving the user's electronic device 108 (Block 344). The server-side transformation application 112 may additionally or alternatively estimate the cost and/or time to download or stream each lower resolution, transformed version of the media data 102 (Block 346). The server-side transformation application 112 may additionally or alternatively perform a cost/benefit analysis of the full-fidelity version and each lower resolution, transformed version, given the processing or graphics capabilities and/or the display size or color capabilities of the user's electronic device 108 (Block 348). The server-side transformation application 112 may then automatically make a selection on the user's behalf, given the channel and device constraints (Block 350). The server-side transformation application 112 then retrieves the automatically-selected version (e.g., the full-fidelity media data 102 or one of the lower resolution, transformed versions) (Block 352) and sends the selected version to the user's electronic device 108 (Block 354).

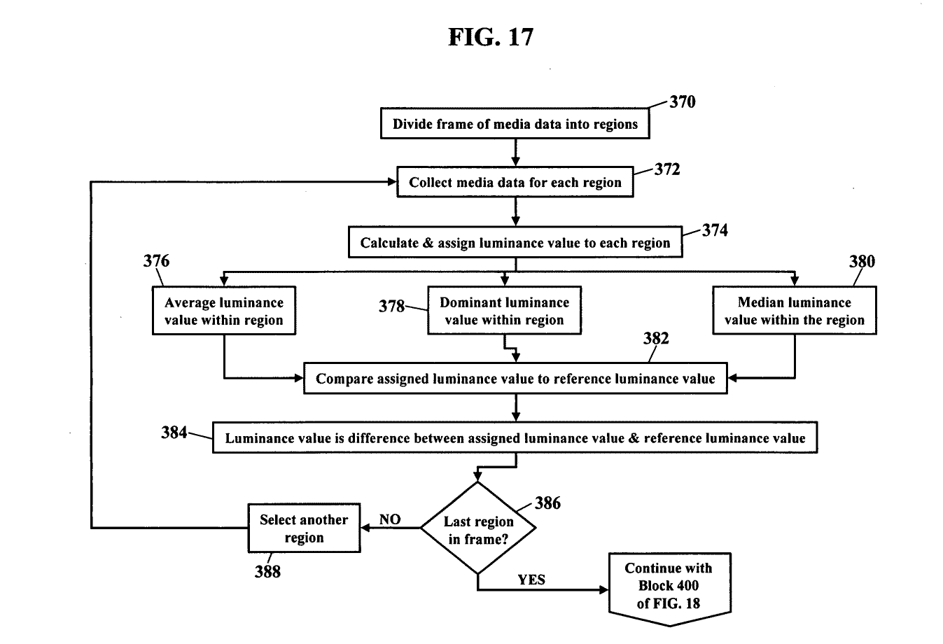

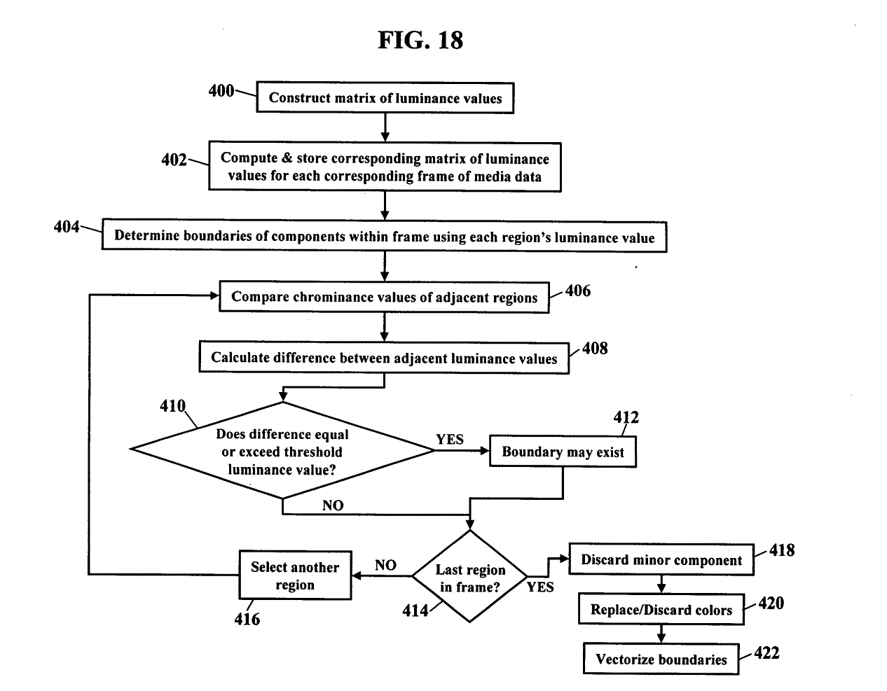

FIGS. 17 and 18 are flowcharts illustrating edge-detection using luminance, according to even more exemplary embodiments. The above paragraphs described the use of chrominance to edge-detect the boundaries of the components within the frame 160. Here, exemplary embodiments may additionally or alternatively utilize luminance to differentiate between the components within the frame 160. The term and concept of luminance, as used herein, describes a difference between a luminous value and a reference luminous value, with the reference luminous value having a specified luminous quality or numeric value. The difference between the luminous value and the reference luminous value is termed “luminance.”

As FIG. 17 illustrates, the frame 160 of the media data 102 may again be divided into regions, such as the regions 180 (as FIG. 4 illustrated) (Block 370). As the above paragraphs explained, the greater the number of the regions 180, then the greater the resolution of the transformation. Regional media data, such as the regional media data 188, is collected for each region (Block 372), and a luminance value is calculated and assigned to each region 180 (Block 374). The assigned luminance value may be an average luminance value of all the numeric luminance values within the region 180 (Block 376). The assigned luminance value may additionally or alternatively be a dominant luminance value that most frequently occurs within the region 180 (Block 378). Exemplary embodiments may tally the different luminance values that occur within the region 180, and the luminance value having the greatest number of occurrences may be dominant. The luminance value may additionally or alternatively be a median luminance value in the spectrum of numeric luminance values that occur within the region 180 (Block 380). Exemplary embodiments may tally the different luminance values that occur within the region 180, determine a Gaussian distribution for the different luminance values, and then compute the median luminance value. Regardless, once the region's luminance value is assigned, the assigned luminance value is compared to a reference luminance value (Block 382). The luminance value is the difference between the assigned luminance value and the reference luminance value (Block 384). If the region 180 is not the last region in the frame (Block 386), then another region is selected (Block 388) and that region's media data is collected (Block 372). If, however, all the regions 180 within the frame have been analyzed (Block 386), then the flowchart continues with FIG. 18. The process, in other words, repeats for each region 180 in the frame 160 until the last luminance value is determined for the last region.

As FIG. 18 illustrates, once the luminance values are calculated for each region 180, a matrix of luminance values is constructed (Block 400). The server-side transformation application 112 may also compute and store a corresponding matrix of luminance values for each corresponding frame 160 of the media data 102 (Block 402). The boundaries 162 of the components within the frame are determined using each region's luminance value (Block 404). The chrominance values 184 of adjacent regions 180 are compared (Block 406) and a difference between the adjacent luminance values is calculated (Block 408). When the difference between the adjacent luminance values exceeds a threshold luminance value (Block 410), then a boundary may exist between the regions 180 (Block 412). If the region 180 is not the last region in the frame (Block 414), then another, adjacent region is selected (Block 416) and the chrominance values 184 of the adjacent regions 180 are compared (Block 406). The process, in other words, repeats for each region 180 in the frame 160 until the last luminance value is compared to the threshold luminance value. If, however, all the regions 180 within the frame have been analyzed (Block 414), then minor components may be discarded (Block 418), and colors may be replaced or discarded to further simply the transformation (Block 420). The boundaries are vectorized (Block 422).

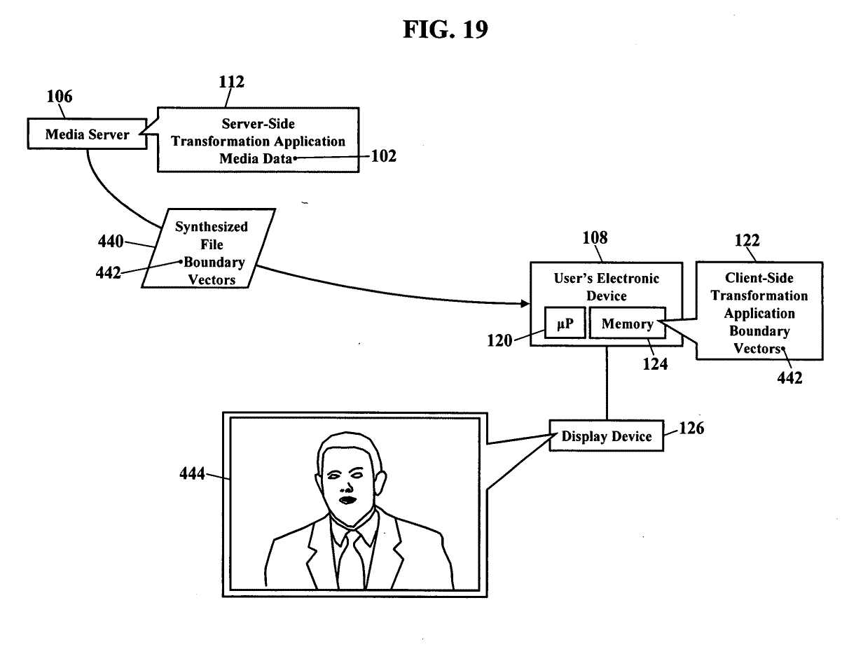

FIG. 19 is a schematic illustrating instantiation at the user's electronic device 108, according to even more exemplary embodiments. Here the server-side transformation application 112 sends a synthesized file 440 that only describes the vectors 442 of the boundaries of the major components (within the frame 160 illustrated in FIG. 3). That is, as the above paragraphs explained, the important features in the media data 102 are automatically detected, analyzed, and in real time transformed into simplified streaming graphics commands which are suitable for transmission to the user's electronic device 108. When the vectors 442 are received at the user's electronic device 108, the client-side transformation application 122 reconstructs the streaming vectors 442. The client-side transformation application 122 causes the processor 120 to display the streaming vectors 442 on a frame-by-frame basis at the display device 126. As FIG. 19 illustrates, a resultant vector image 444 is obviously synthetic, but also, realistic. Because the boundary vectors 442 may be streamed in real-time, or near real-time, the synthetic image 444 still conveys adequate information and meaning by gestures, voice, and even interaction.

The boundary vectors may be manipulated. Because the boundary vectors 442 are mathematical, the user's electronic device 108 may easily manipulate the boundary vectors 442. The user's electronic device 108, for example, may easily “zoom” the boundary vectors 442 without losing quality. Because the boundary vectors 442 may be mathematically manipulated, the user's electronic device 108 may process the boundary vectors 442 without a further loss in resolution.

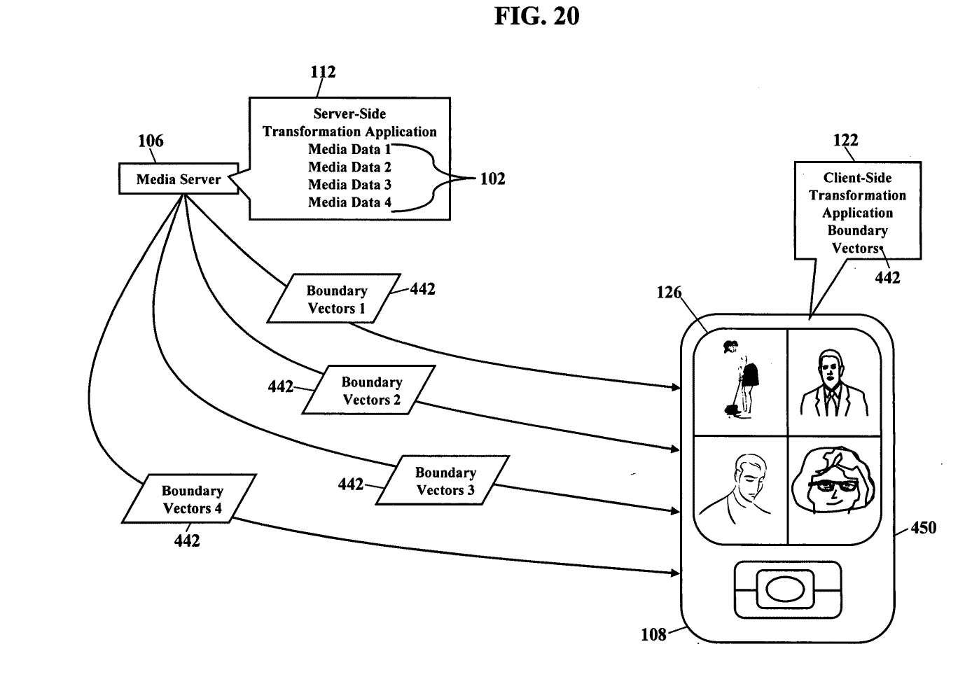

FIG. 20 is a schematic illustrating multiple instantiations at the user's electronic device 108, according to even more exemplary embodiments. Because the boundary vectors 442 are minimalistic representations of the full-fidelity media data 102, exemplary embodiments may be used to perform several different instantiations at the user's electronic device 108. That is, several vector transformations may be simultaneously received and rendered, even on a limited bandwidth device. The processing power of the media server 106 (e.g., at the encoding end) is used to simplify the graphics in real time. At the receiving, or instantiation end (e.g., the user's electronic device 108), only minimal processing power is needed to render the boundary vectors 442. The communications channel that conveys the boundary vectors 442 also has relaxed bandwidth requirements, because less information is being transmitted. Because the vector transformations may require far less channel resources and processing capabilities, the efficiency gains may permit multiple instantiations at the user's electronic device 108. FIG. 20, for example, illustrates how the user's electronic device 108 may receive, process, and display multiple communications or feeds from multiple buddies. The display device 126 may be divided into separate scenes or areas, such that each buddy's feed may be rendered in a different area. FIG. 20, for example, illustrates how four people may be viewable in real time on a cell phone/PDA 450, because of the reduced bandwidth requirements of each buddy's vector representation. That is, because each boundary vector file 442 is a minimalistic representation of each buddy's corresponding full-fidelity media data 102, the cell phone/PDA 450 may simultaneously, or nearly simultaneously, process and display an audio-visual communication from each buddy. Again, even though each buddy's representation is synthetic, each buddy's vector representation is realistic enough to adequately convey information and meaning. When the user desires, a buddy's vector representation may even be “zoomed” for emphasis.

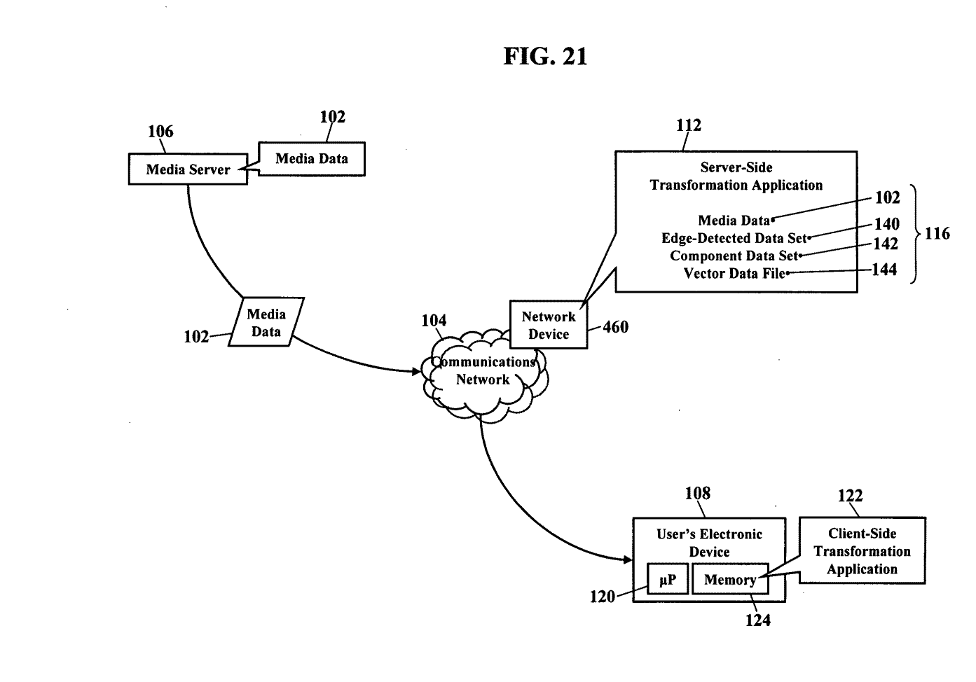

FIG. 21 is a schematic illustrating another operating environment, according to even more exemplary embodiments. Here the server-side transformation application 112 may at least partially operate within a network device 460, such as a network server or network component. When the user's electronic device 108 requests the media data 102 from the media server 106, here the server-side transformation application 112 may add an intelligent component to the communications network 104. That is, in this operating environment, the communications network 104 may transform the media data 102 into the lower-resolution data sets 116 explained above. The network device 460 may intelligently monitor the communications network 104 and determine what (if any) lower-resolution transformation best suits the channel serving the user's electronic device 108. The network device 460 may monitor bandwidth, traffic, and even the capabilities of the user's electronic device 108 to determine the cost and time to download the media data 102 and its lower-resolution transformations.

Exemplary embodiments may also gracefully revert to boundary vectors. As this disclosure has explained, network conditions may determine which transformation best serves the user's electronic device 108. Exemplary embodiments, however, may even dynamically switch to different transformations, depending upon network conditions. When, for example, network congestion is low, exemplary embodiments may begin streaming the full-fidelity media data 102. Should network congestion increase, exemplary embodiments may detect the congestion and automatically switch and stream the lower-resolution, edge-detected version 140 of the media data 102. If a bandwidth bottleneck is encountered, exemplary embodiments may even drop-down and continue streaming only the boundary vectors 144. As bandwidth improves, exemplary embodiments may revert and resume streaming a higher-resolution version, such as edge-detected version 140. When conditions permit, exemplary embodiments may even resume streaming the full-fidelity media data 102. These dynamic transformations may be performed gradually and/or gracefully, based on network conditions. The server-side transformation application 112 (and/or the client-side transformation application 122) may intelligently toggle between the full-fidelity media data 102 and any of the various lower-bandwidth data sets 116, depending on network and/or device constraints. Exemplary embodiments may thus decide which data is most efficiently sent and/or received, given the current network and/or device constraints.

Exemplary embodiments may also affect the capabilities of the user's electronic device 108. Because exemplary embodiments transform the full-fidelity media data 102 into the various lower-bandwidth data sets 116, the user's electronic device 108 may have reduced capabilities. That is, because the lower-bandwidth transformations require less end-device capabilities, the user's electronic device 108 need not have processing, memory, and display characteristics to render the full-fidelity media data 102. Exemplary embodiments permit the user to utilize a less-capable device and still receive meaningful video, for example. As manufacturers strive to produce less costly electronic devices (such as a $100 laptop), exemplary embodiments provide viable design choices to reduce costs. Moreover, exemplary embodiments also demonstrate that the user need not have access to an expensive, high-speed connection to enjoy meaningful video content.

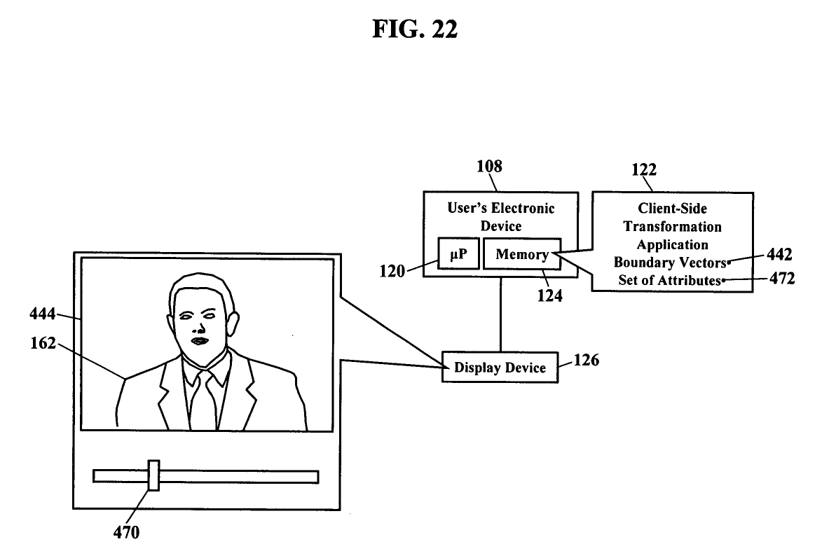

FIG. 22 is a schematic illustrating color selections, according to even more exemplary embodiments. As the above paragraphs explained, exemplary embodiments may transform the full-fidelity media data (illustrated as reference numeral in FIG. 21) into the boundary vectors 442. Exemplary embodiments thus transform the media data 102 into a synthesized, black-and-white, minimalistic tracing 164 of the mathematical boundary vectors 442 (as FIGS. 3 and 13 illustrated). When these boundary vectors 442 are received at the user's electronic device 108, the streaming vectorized images 444 are reconstructed using a simplified subset of the original images. The user may choose to view the vectorized images 444 in their black-and-white, minimalistic representation. The user, however, may instead view the vectorized images 444 using standardized colors, luminance, and/or motion characteristics.

FIG. 22 illustrates user-selectable color schemes. Even though the vectorized images 444 may be black-and-white, minimalistic representations, the user may apply various color schemes to alter the synthesized images 444. FIG. 22 illustrates a graphical user interface xx in which the boundaries 162 are rendered. Recall that the boundaries 162 are outlines of the edge-detected components within the media data 102. The client-side transformation application 122 may then permit the user add colors of the user's choices. That is, exemplary embodiments may permit the user to format or paint the synthesized image 444. FIG. 22, for example, illustrates a graphical software control, such as a slider 470, that allows the user to select one or more colors within the synthesized image 444. The user may this choose skin color, hair color, and clothing color, for example, to suit the user's desires. The user, for example, may select an area within the synthesized image 444 and move the slider 470 to select the color of the chosen area. The slider 470 may represent a palette of colors from which the user may choose (or which the user's electronic device 108 may have the capability to produce). The client-side transformation application 122 may then fill, or paint, the selected outline in the chosen color. The client-side transformation application 122 may even permit the selection of patterns and/or multiple color schemes for different components/outlines. The user's selections may thus be a set 472 of attributes, or “skins,” that are applied to the current synthesized frame image 444 and/or subsequent synthesized frame images. The set 472 of attributes may even be associated with a sender and saved, such that the same set 472 of attributes is applied to any other communications from the same sender.

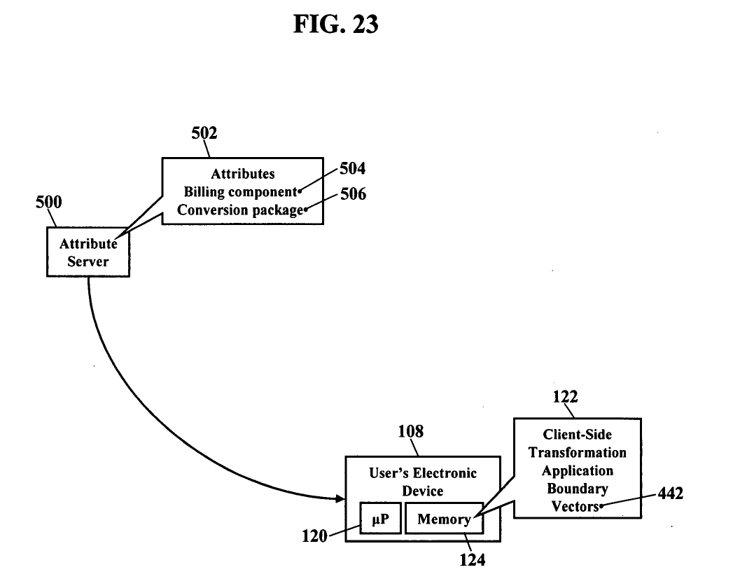

FIG. 23 is a schematic illustrating downloadable attributes, according to even more exemplary embodiments. An attribute server 500 may store attributes 502, such as colors, patterns, and audio selections, from which the user may select and download to the user's electronic device 108. The user may then associate and apply the downloaded attributes 502 to individual senders and/or to synthetic images. Exemplary embodiments, for example, may permit the user to always associate the color red to mother's hair. Brother Bill may always have a blue shirt. Sister Sally may always have a plaid dress. The attribute server 500 may even include a billing component 504 that charges the user, or the user's account, for the downloaded attributes 502.

More interesting, however, is the substitution of audio and images. Exemplary embodiments may permit the user to download conversion packages 506 from the attribute server 500. These conversion packages 506 convert received sounds, voices, music, and even graphics into different representations or forms. Suppose the user prefers to hear Homer Simpson's voice to Brother Bills' voice. The user may download the appropriate conversion package 506 associated with Homer Simpson. When an audible communication is received from Brother Bill, exemplary embodiments may then substitute Homer Simpson's voice for Brother Bill's voice. Real-time source information (such as the sender's I.P. communications address, email address, or telephone number) may be used to identify the sender, verify identity, and even apply attributes 502 and the conversion packages 506. As another example, Homer Simpson's conversion package 506 may also convert Brother Bill's boundary vectors 442 into Homer Simpson's image. That is, the conversion package 506 would transform Brother Bill's boundary vectors 442 into Homer Simpson's image. As Brother Bill's mathematical vectors 442 exhibit curl and/or gradient changes, for example, those same curl and/or gradient changes may be applied to the vectors 442 describing Homer Simpson's image. Conversion packages 506 may also permit morphing of images, such that Brother Bill's mathematical vectors 442 gradually change into Homer Simpson's corresponding image vectors 442. Conversion packages 506 may also permit the addition of attributes 502 (e.g., mustache, beard, or hat) to an image.

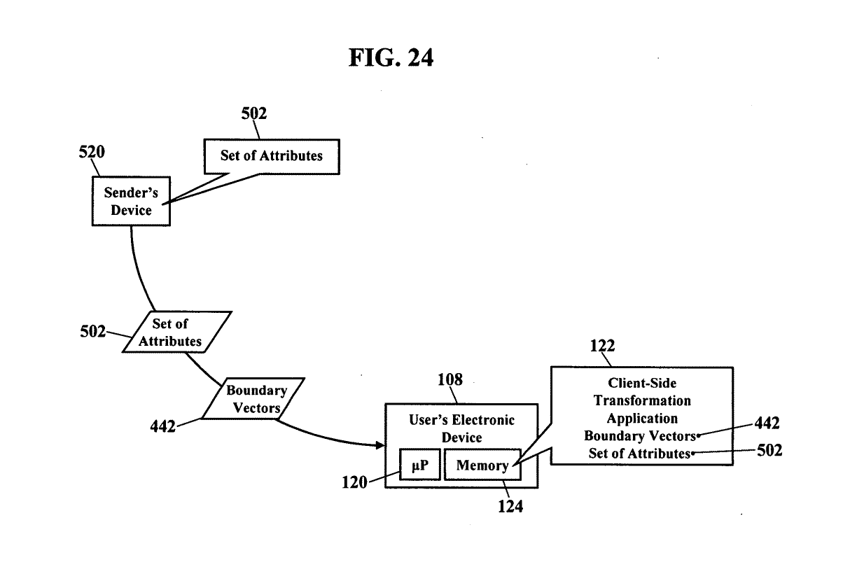

FIG. 24 is a schematic illustrating the transmission of attributes 502, according to even more exemplary embodiments. Here a sender, at a sender's device 520, may send, or “push,” the set 502 of attributes to accompany the sender's boundary vectors 442. When the user's electronic device 108 receives the sender's boundary vectors 442, the client-side transformation application 122 may render the sender's boundary vectors 442 using the “pushed” set 502 of attributes. In other words, the sender's image may be rendered according to the pushed set 502 of attributes, rather than the sender's actual appearance. Suppose, for example, the sender calls during the early morning hours, before dressing in business attire. Exemplary embodiments thus permit the sender to push the set 502 of attributes, such that the client-side transformation application 122 renders the sender in business attire, regardless of the sender's current appearance. Exemplary embodiments may even permit the sender to push an entirely different set 502 of attributes, such that the sender is rendered at the user's electronic device 108 as an alias (e.g., Humphrey Bogart or George Washington). Similarly, exemplary embodiments may permit the user, at the user's electronic device 108, to push an alias identity when communicating with the sender. Actors, actresses, and news organizations are just some entities that may utilize exemplary embodiments with little or no regard for an individual's, or a location's, actual appearance.

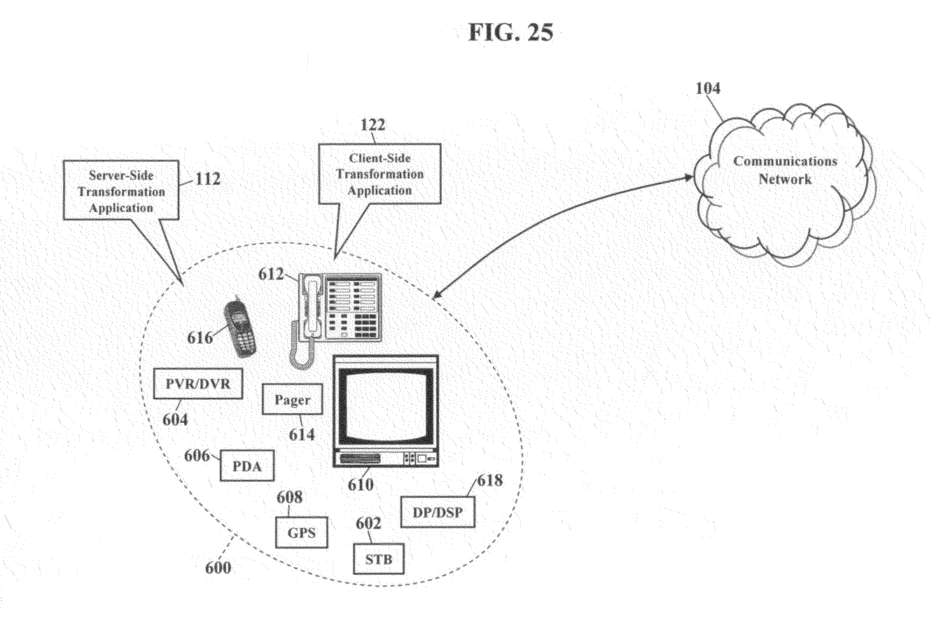

FIG. 25 depicts other possible operating environments, according to more exemplary embodiments. FIG. 25 illustrates that the server-side transformation application 112 and/or the client-side transformation application 122 may alternatively or additionally operate within various other communications devices 600. FIG. 25, for example, illustrates that the server-side transformation application 112 and/or the client-side transformation application 122 may entirely or partially operate within a set-top box (602), a personal/digital video recorder (PVR/DVR) 604, personal digital assistant (PDA) 606, a Global Positioning System (GPS) device 608, an interactive television 610, an Internet Protocol (IP) phone 612, a pager 614, a cellular/satellite phone 616, or any computer system and/or communications device utilizing a digital processor or digital signal processor (DP/DSP) 618. The communications device 600 may also include watches, radios, vehicle electronics, clocks, printers, gateways, and other apparatuses and systems. Because the architecture and operating principles of the various communications devices 600 are well known, the hardware and software components of the various communications devices 600 are not further shown and described. If, however, the reader desires more details, the reader is invited to consult the following sources: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

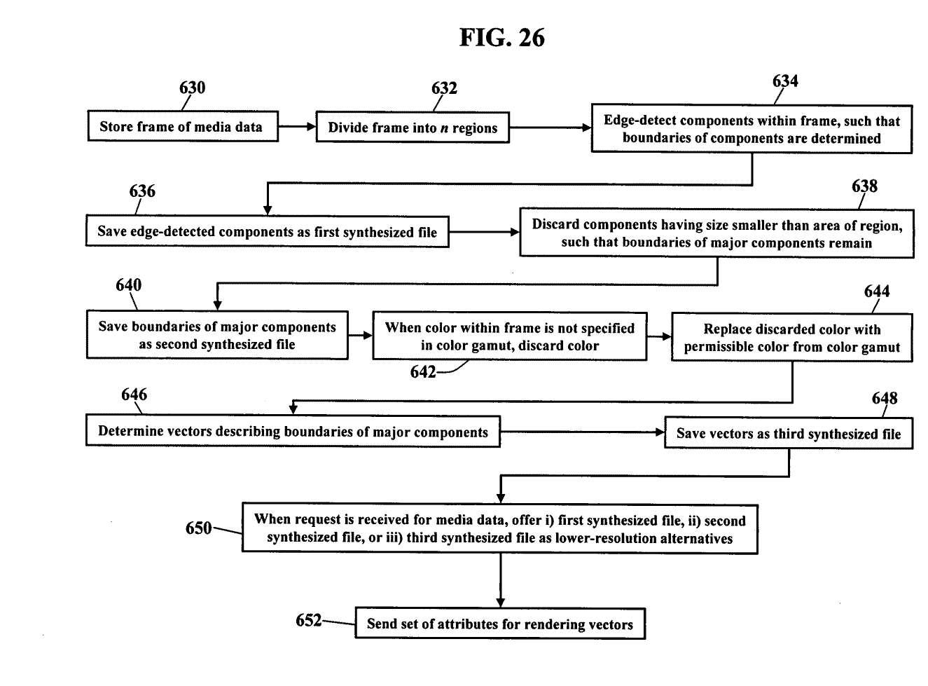

FIG. 26 is a flowchart illustrating a method of transforming media data, according to still more exemplary embodiments. A frame of media data is stored (Block 630). The frame is divided into n regions (Block 632). The components within the frame are edge detected, such that boundaries of the components are determined (Block 634). The edge-detected components are saved as a first synthesized file describing the frame of media data (Block 636). Any components having a size smaller than an area of a region are minor components and discarded, such that the boundaries of the major components remain (Block 638). The boundaries of the major components are saved as a second synthesized file describing the frame of media data (Block 640). When a color within the frame is not specified in a color gamut, the color may be discarded (Block 642) and replaced (Block 644). Vectors describing the boundaries of the major components are determined (Block 646) and saved as a third synthesized file describing the frame of media data (Block 648). When a request is received for the frame of media data, then a lower resolution alternative may be offered, the lower resolution alternative comprising at least one of i) the first synthesized file describing the edge-detected components, ii) the second synthesized file describing the major components of the scene, and iii) the third synthesized file of the vectors describing the boundaries of the major components of the scene (Block 650). A set of attributes may be sent, such that the vectors describing the boundaries of the major components will be rendered using the set of attributes (Block 652).

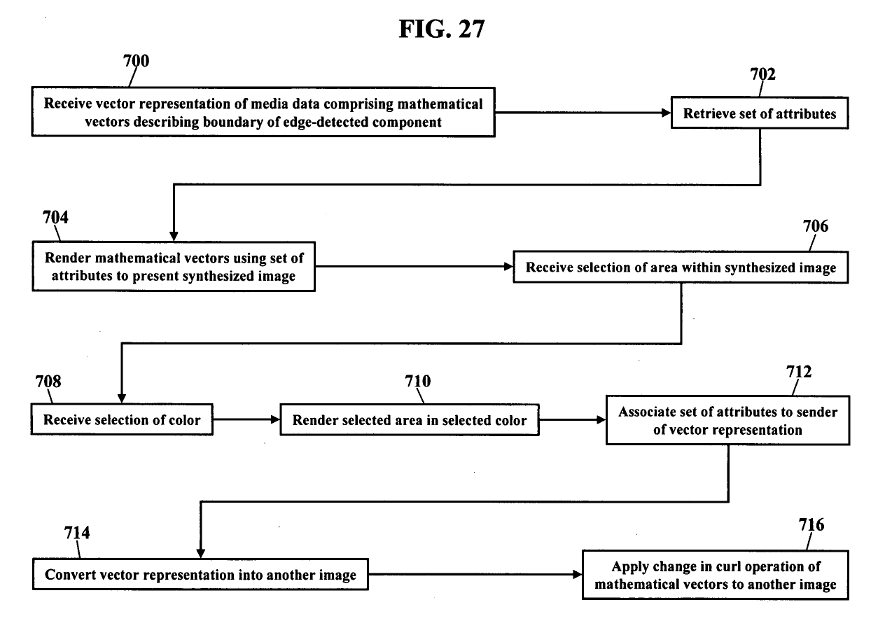

FIG. 27 is a flowchart illustrating a method of rendering media data, according to still more exemplary embodiments. A vector representation of the media data is received, with the vector representation comprising mathematical vectors that describe a boundary of an edge-detected component within a frame of the media data (Block 700). A set of attributes may be retrieved (Block 702). The mathematical vectors are rendered using the set of attributes to present a synthesized image of the media data (Block 704). A selection of an area within the synthesized image is received (Block 706). A selection of a color is also received (Block 708), and the selected area is rendered in the selected color (Block 710). The set of attributes may be associated to a sender of the vector representation of the media data (Block 712). The vector representation of the media data may be converted into another image (Block 714). A change in a curl operation of the mathematical vectors may be applied to another image (Block 716).

The server-side transformation application 112 and/or the client-side transformation application 122 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments, allow easier dissemination of exemplary embodiments. A computer program product comprises the computer readable medium storing processor-executable instruction for transforming the media data 102 into lower-resolution versions.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of transforming media data, comprising:
storing a frame of media data;
edge detecting components of a scene within the frame, such that boundaries of the components within the scene are determined;
saving the edge-detected components as a first synthesized file describing the frame of media data;
discarding minor components within the scene, such that major components remain;
saving the major components as a second synthesized file describing the frame of media data;
determining vectors describing the boundaries of the major components;
saving the vectors as a third synthesized file describing the frame of media data.

2. The method according to claim 1, wherein edge detecting the components comprises comparing a chrominance of a region in the frame to the chrominance of an adjacent region in the frame.

3. The method according to claim 2, wherein if the chrominance of the region differs from the chrominance of an adjacent region by a threshold chrominance value, then defining a boundary of a component of the scene.

4. The method according to claim 2, wherein if the chrominance between the region and the adjacent region does not differ by the threshold chrominance value, then choosing another region for comparison.

5. The method according to claim 1, wherein edge detecting the components comprises comparing a luminance of a region in the frame to the luminance of an adjacent region in the frame.

6. The method according to claim 5, wherein if the luminance of the region differs from the luminance of an adjacent region by a threshold luminance value, then defining a boundary of a component of the scene.

7. The method according to claim 5, wherein if the luminance between the region and the adjacent region does not differ by the threshold luminance value, then choosing another region for comparison.

8. The method according to claim 1, further comprising:
dividing the frame into n regions; and
discarding components having a size smaller than an area of a region.

9. The method according to claim 1, further comprising discarding a color from the frame according to a color gamut, such that a color of a component is discarded if not specified in the color gamut.

10. The method according to claim 9, further comprising replacing the discarded color with another color in the color gamut.

11. The method according to claim 1, further comprising:
receiving a request for the frame of media data; and
offering a lower resolution alternative to the media data, the lower resolution alternative comprising at least one of i) the first synthesized file describing the edge-detected components, ii) the second synthesized file describing the major components of the scene, and iii) the third synthesized file of the vectors describing the boundaries of the major components of the scene.

12. The method according to claim 11, further comprising communicating a cost to provide the frame of media data and to provide the lower resolution alternative.

13. The method according to claim 1, further comprising pushing a set of attributes with the third synthesized file, such that the vectors describing the boundaries of the major components will be rendered using the set of attributes.

14. A method of rendering media data, comprising:
receiving a vector representation of the media data, the vector representation comprising mathematical vectors that describe a boundary of an edge-detected component within a frame of the media data;
retrieving a set of attributes; and
rendering the mathematical vectors using the set of attributes to present a synthesized image of the media data.

15. The method according to claim 14, further comprising:
receiving a selection of an area within the synthesized image;
receiving another selection of a color; and
rendering the selected area in the selected color.

16. The method according to claim 14, further comprising associating the set of attributes to a sender of the vector representation of the media data.

17. The method according to claim 14, further comprising downloading the set of attributes.

18. The method according to claim 14, further comprising converting the vector representation of the media data into another image.

19. The method according to claim 14, further comprising applying change in curl of the mathematical vectors to another image.

20. A system for transforming media data, comprising:
means for storing a frame of media data;
means for comparing a chrominance of a region in the frame to the chrominance of an adjacent region in the frame;
means for edge detecting boundaries of components within the frame using the chrominance;
means for saving the edge-detected boundaries of the components as a first synthesized file;
means for discarding minor components within the frame, such that major components remain;
means for saving the major components as a second synthesized file;
means for determining mathematical vectors describing the boundaries of the major components;
means for saving the mathematical vectors as a third synthesized file;
means for receiving a request for the media data; and
means for sending a lower resolution alternative to the media data, the lower resolution alternative comprising at least one of i) the first synthesized file describing the edge-detected components, ii) the second synthesized file describing the major components within the frame, and iii) the third synthesized file of the mathematical vectors describing the boundaries of the major components within the frame.
